(19) United States
(12) Patent Application Publication
(10) Pub. No.: US 2007/0120707 A1
(43) Pub. Date: May 31, 2007

(54) METHOD FOR POSITIONING RECREATIONAL VEHICLES AND PORTABLE POSITION SENSOR AND ALERT SYSTEM FOR RECREATIONAL VEHICLES AND OTHER VEHICLES

(75) Inventors: Edward J Donnelly, Allison Park, PA (US); Ronald Cyprowski, Verona, PA (US)

Correspondence Address: BLYNN L. SHIDELER;THE BLK LAW GROUP, 3500 BROKKTREE ROAD, SUITE 200, WEXFORD, PA, 15090, US

(73) Assignee: RV INSITE, INC., Pittsburgh, PA (US)

(21) Appl. No.: 11/563,802

(22) Filed: Nov. 28, 2006

Related U.S. Application Data
(60) Provisional application No. 60/740,442, filed on Nov. 29, 2005.

(51) Int. Cl. G08G 1/01

(52) U.S. Cl. 340/933

(57) ABSTRACT

A portable vehicle position sensor and alert system comprises a portable limit point sensor configured to be positioned by the user in a position to receive at least one tire of the vehicle to be positioned thereon when the vehicle is in a desired position, wherein the sensor is configured to generate a signal when the tire is positioned thereon, and an audible and or visual alarm coupled to the sensor and actuated at least when the sensor generates the signal that the vehicle is in the desired position. A wireless configuration of the position and alert system is disclosed.

This application claims the benefit of U.S. Provisional patent application Ser. No. 60/740,442 filed Nov. 29, 2005 entitled “Portable Position Sensor and Alert System for Recreational Vehicles and other Vehicles.”

### BACKGROUND OF THE INVENTION

1. Field of the Invention

The present invention relates to vehicle positioning or parking guides and more particularly to aids for positioning recreational vehicles (RVs).

2. BACKGROUND INFORMATION

Operators of RV's such as travel trailers, fifth-wheel travel trailers, motor-homes, and truck campers are routinely faced with the task of positioning (i.e. parking) the vehicle at destinations such as campgrounds, driveways, storage locations, etc. Often, with limited visibility, the RV must be backed into a location that may be bordered by obstructions such as trees, concrete curb stops, picnic tables, utility posts, or other impediments that could cause damage to the vehicle. Typically, the operator must exit the vehicle multiple times, to check the progression of the RV as it is maneuvered into position. Alternately, the operator may employ second person to verbally relay the positioning progress. Errors or delays in communication between the parties can have significantly detrimental results. Care must be taken if an obstacle is present. Damage to the exterior or undercarriage of the RV is possible if the operator incorrectly judges distances to an obstruction.

The task of parking is further complicated if the RV needs to be leveled due to the gradient of the parking site. A common leveling practice is to place graduated leveling blocks, that are typically made of wood or other common materials, in front of, or behind the tires of low side of the RV. The operator must then move the RV onto the graduated leveling blocks until the RV is level. The operator must take great care not to drive off the back end of the graduated leveling blocks. Depending on the height of the leveling blocks, a drop of 6″ or more could occur if the distance is misjudged. This error can result in the “kicking out” of the leveling blocks which would require the leveling process to be restarted, and possibly damage the leveling blocks or surrounding elements. As previously stated, the operator must exit the vehicle several times to check the positioning progress, or employ second person to relay, generally verbally and/or with hand signals if the person can be positioned within a line of sight of the driver (via a side mirror typically), the vehicle progress on the leveling blocks.

It is an object of the present invention to minimize the drawbacks of the existing technology and to provide a simple easy method of parking an RV or the like and an associated device.

### SUMMARY OF THE INVENTION

It is noted that, as used in this specification and the appended claims, the singular forms “a,” “an,” and “the” include plural referents unless expressly and unequivocally limited to one referent. For the purposes of this specification, unless otherwise indicated, all numbers expressing any parameters used in the specification and claims are to be understood as being modified in all instances by the term “about.” All numerical ranges herein include all numerical values and ranges of all numerical values within the recited numerical ranges.

The various embodiments and examples of the present invention as presented herein are understood to be illustrative of the present invention and not restrictive thereof and are non-limiting with respect to the scope of the invention.

The present invention provides an affordable position sensing and alarm device that can be utilized to indicate vehicle transit up to or past a predetermined limit point. The device can be utilized to aid in the positioning of recreational vehicles (RV's) and other vehicles such as automobiles, trucks, utility trailers, etc.

The device described in this document can be utilized to aid in the positioning of RV's and other vehicles by providing an audible and or visual indication that the vehicle has reached a predetermined limit point. This portable device provides an accurate, easy-to-use, low cost limit point transition indication. By placing the limit sensor strip at the desired limit point (i.e. end of leveling blocks or maximum desired travel), the operator is free to move the vehicle until an audible or visual alarm is activated. The device provides a loud audible alarm that can be heard from within the cab of a tow vehicle, motor-home or other vehicle. Alerted that the predefined limit of travel has been reached, the operator can halt the movement of the vehicle.

The device can also be implemented utilizing wireless technology. With this configuration the limit point sensor can be linked to a remote receiver located inside the vehicle driver's compartment via a wireless telemetry link. Activation of the limit point sensor by the vehicle tire will trigger audible and or visual alarms in the remote receiver unit.

A portable device has been developed that provides an audible and or visual alarm when a vehicle tire moves to a pre-positioned limit point sensor. The device consists of a light weight limit point sensor, acoustic alarm element, power source, and enclosure housing. The limit point sensor may consist of a pressure transducer, contact switch or other tactile type sensor. In a simple configuration, the limit point sensor will provide an electrical contact that when closed by an external force, i.e. vehicle tire, will energize the acoustic alarm element. Other configurations of the limit point sensor may require additional circuitry to process the sensor output signal into a usable form.

The limit point sensor consists of a water resistant flexible strip that is capable of withstanding repeated exposure to the mechanical forces exerted by a vehicle tire. The sensor may be configured in various lengths. Depending on individual preferences, a sensor strip length of one to four feet or more can be selected for use. The sensor lengths are interchangeable with the system. The sensor will be terminated with a wire conductor that will connect to the alarm enclosure via a hardwired connection or a removable connector. Incorporating a removable connector will facilitate sensor replacement if a different length is desired or the sensor is damaged.

The device may include an alarm module that incorporates an acoustic alarm element that will provide a loud audible enunciation when the limit point sensor is activated. The alarm module may also incorporate circuitry to process the limit point sensor output signal and provide features such as an alarm timeout if the sensor is activated continuously for a defined interval.

To facilitate alarm reconnection in noisy environments or when employed by hearing impaired users, the acoustic alarm element may emit a sweeping tone that alternates between a low and a high audio frequency. Other tone variations may also be utilized such as beep, siren or warble tone. The acoustic alarm element will emit a tone of sufficient sound pressure to be detectable in the intended operating environment. The acoustic alarm element may be water resistant and mounted on or in the device enclosure.

The device enclosure may house the acoustic alarm element, limit point sensor processing circuitry, battery power source, and the limit point sensor connection interface. The enclosure may be water resistant. The enclosure may incorporate a user accessible battery compartment.

The device is small, lightweight, portable, and simple to operate; therefore a user can quickly position the system for operation. A typical usage scenario would consist of connecting the limit point sensor to the alarm module enclosure and activating the sensor to insure proper operation. The sensor would then be positioned at the desired vehicle travel boundary. The user would move the vehicle until the desired position is reached or the audible alarm sounds. This system can also be utilized for home garage use. The limit point sensor can be located on the garage floor at the maximum vehicle travel point. Sounding of the alarm will alert the driver that the maximum limit has been reached.

The present invention can also be implemented utilizing wireless technology. In this configuration the limit point sensor is linked to a remote receiver located inside the vehicle driver's compartment via a wireless telemetry link. When the limit point sensor is activated due to pressure from the vehicle tire, an activation signal will be transmitted to the remote receiver. This will result in the activation of receiver visual and or audio alarms. This mechanism will provide the RV operator with real-time feedback as to when the limit point has been reached. In order to detect erroneous operation of the system, the remote receiver has been designed to provide the operator with an indication of the limit point sensor functionality and telemetry link status. This is in addition to the sensor activation alarms stated above. The purpose of this feature is to provide the operator with real-time feedback that the system is functioning properly during RV maneuvering. If the limit point sensor transmitter is not functioning properly (i.e. not powered up or battery is depleted), the remote receiver will alert the operator by activation of an indicator light and or alarm.

These and other advantages of the present invention will be clarified in the brief description of the preferred embodiment taken together with the drawings in which like reference numerals represent like elements throughout.

### BRIEF DESCRIPTION OF THE DRAWINGS

FIG. 1 is a schematic perspective view of a portable position sensor and alert system according to one aspect of the present invention;

FIG. 2 is a schematic perspective view of a portable position sensor and alert system according to another aspect of the present invention;

FIGS. 3-5 are is a schematic side elevation views of the steps of using the portable position sensor and alert system for positioning a vehicle according to one aspect of the present invention;

FIG. 6 is a schematic circuit diagram of the portable position sensor and alert system of FIG. 1;

FIG. 7 is a schematic circuit diagram of a sensor and transmitter portion of the portable position sensor and alert system of FIG. 2; and

FIG. 8 is a schematic circuit diagram of a receiver and alarm portion of the portable position sensor and alert system of FIG. 2.

### DESCRIPTION OF THE PREFERRED EMBODIMENTS

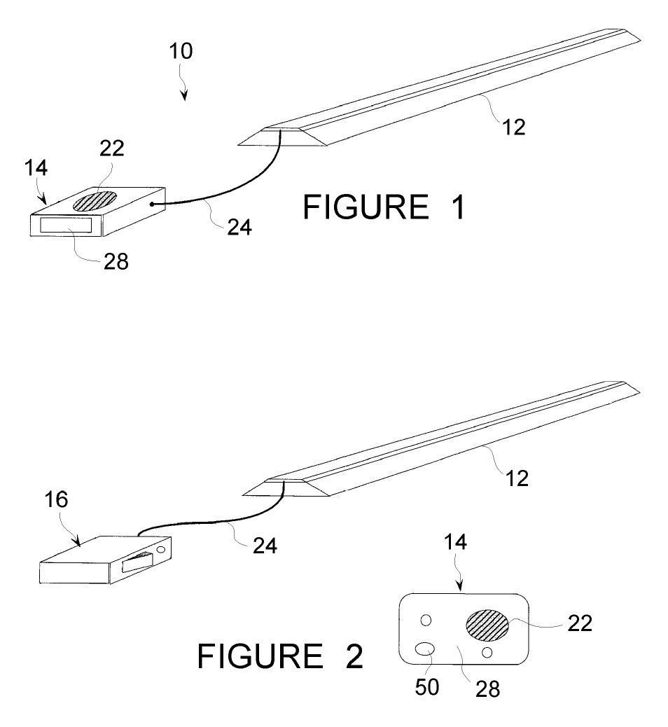

The present invention can be implemented as a stand-alone device 10 consisting of a limit point sensor 12 and an alarm module 14 as shown in FIG. 1 and described below, or as a wireless system 10′ consisting of the limit point sensor 12, a transmitter module 16 and a remotely positioned alarm module 14 with a receiver as shown in FIG. 2 and described below.

Stand-Alone System

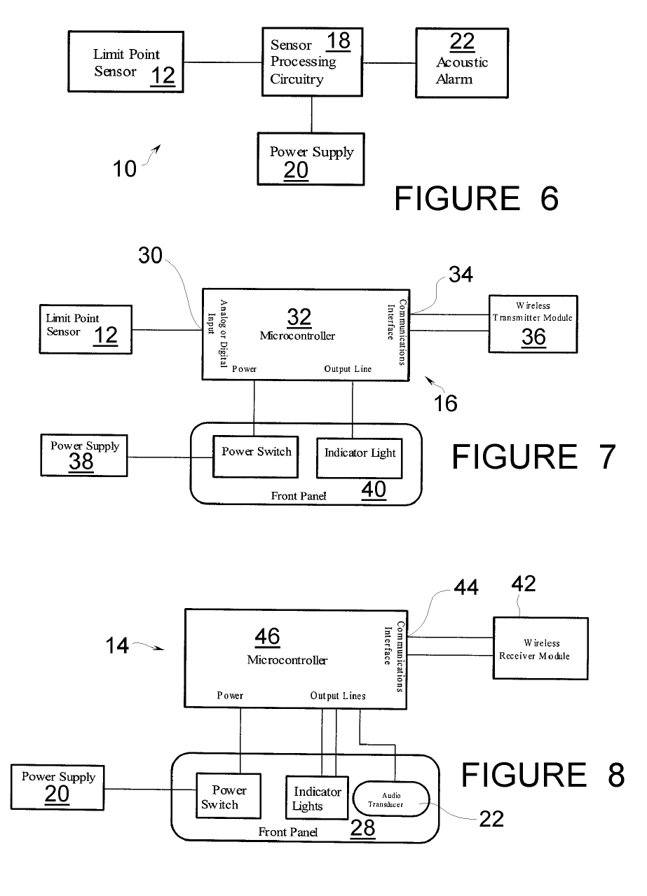

The circuit for the stand-alone device is shown in FIG. 6. This system consists of a Limit Point Sensor 12, appropriate Sensor Processing Circuitry 18, a Power Supply 20, and an Acoustic Alarm 22 in the alarm module 12.

The Limit Point Sensor 12 consists of a water resistant, water proof, flexible strip that provides an electrical switch contact or analog signal when mechanical forces are externally applied. The switch is closed when the vehicle tires are on the sensor 12, and the strip is formed of a sufficiently durable material to withstand repeated vehicle use. A strip formed of 3/16″ thick and 1″ wide vinyl rubber on the base with a flexible PVC strip-switch secured on top such, as through adhesive or the like, forms an effective sensor 12. The base is suitable to hold the sensor in place through manual placement preventing tipping, rolling or sliding of the sensor when engaged by the tire, thereby providing an effective portable device. In other applications, such as home garage use, a smaller base or an adhesive backed strip-switch may be utilized where portability is not critical. Obviously, adhesives or other fastening devices may be used with the current strip where portability is not a primary concern to the user. Suitable strip-switches are available from Switches and Sensors, Inc. in any desired length. Other switch types, such as a breaking the beam type sensor, a piezo-electric device, or proximity sensors can be utilized, however the mechanical closing pressure switch has been found to be cost effective and durable. As noted above the sensor 12 is coupled to the circuitry 18 within the alarm module 14 through a wire 24. The alarm module 24 may have further indicating lights and controls (such as power control, volume control, signal selection control, etc) on panel 28.

The Sensor Processing Circuitry 18 processes the output signal of the Limit Point Sensor 12 and provides activation control of the Acoustic Alarm 22. Depending on the type of Acoustic Alarm utilized, the Sensor Processing Circuitry may include tone generating circuitry that will be used to drive the alarm 22. The Sensor Processing Circuitry 18 may provide an alarm timeout feature that terminates alarm activation after a defined interval if continuous force is applied to the Limit Point Sensor 12.

The Power Supply 20 consists of a battery of primary or secondary cells. The battery will provide sufficient voltage and current to drive the Sensor Processing Circuitry 18 and the Acoustic Alarm 22.

The Acoustic Alarm 22 consists of an electromechanical acoustic generator such as a piezoelectric transducer. The Acoustic Alarm 22 may, itself incorporate tone generating circuitry. To facilitate alarm reconnection in noisy environments or when employed by hearing impaired users, the Acoustic Alarm 22 may emit a sweeping tone that alternates between a low and a high audio frequency. In addition to the alarm 22, a visible indicator light or visual alarm, such as a strobe or flashing LED element may be used in the alarm module 14 to provide visual indication of the activation of the sensor 12. The term alarm encompasses audible or visible alarm mechanisms as described and it is contemplated that the alarm module 14 may have a selector switch to allow one, or the other or both alarms to be selected by the user.

Wireless System

The circuitry for the wireless system 10′ is shown in FIG. 7 and FIG. 8. This configuration consists of the Transmitter module 16 as shown in FIG. 7 and a remotely positioned alarm module 14 as shown in FIG. 8.

The sensor 12 will generate a signal received in the input 30 of the controller 32 in the transmitter module 16. The controller 32 communicates with the wireless transmitter 34 through communications interface 36. Power is supplied through a power supply 38 through controls on panel 40.

The alarm module 14 receives a signal from transmitter 34 in an associated receiver 42 that communicates through interface 44 with controller 46. The controller 46 is analogous to the circuitry 18 of device 10 and it drives the alarm 22. The alarm 22 may be in a front panel with other controls and indicator lights, or may be otherwise located within the module 14 as desired.

The transmitter 34 and the receiver 42 form a transmitter and receiver pair. Each Transmitter and Receiver pair will be matched to each other using a unique identification tag. All data transmissions will include the identification tag of the sender. The alarm module 14 with receiver 42 will process received data transmissions only from the associated Transmitter 34. All other received data transmissions will be discarded.

Wireless System—Transmitter Module

The Transmitter module 16 is coupled to the Limit Point Sensor 12 and includes the Microcontroller 32 (or other control circuitry), Wireless Transmitter 36, Power Supply 38, Power Switch, and a Power Indicator Light. The module 16 is energized by activation of the Power Switch. The Power Supply 38 consists of a battery of primary or secondary cells. The Microcontroller 32 monitors the state of the Limit Point Sensor 12 via analog or digital input lines 30. The Microcontroller 32 also interfaces to the Wireless Transmitter module 36 via a control and communication interface 34. In order to conserve battery power, the Microcontroller 32 may remove power from the Wireless Transmitter module 36 when transmissions are not scheduled. Periodically, the Microcontroller 32 will initiate a system status transmission to the Remote Receiver module 42. The transmitted data will be sent in frames or packets. Each frame will contain status of the Limit Point Sensor 12 and other information such as battery voltage. The data frame will incorporate error detection information such as a numeric checksum or CRC calculation.

In addition to the periodic status transmission, the Microcontroller 32 will transmit a status frame if the Limit Point Sensor 12 is activated. The Microcontroller 32 may also control the activation of the front panel Indicator Light of panel 40. The Indicator Light will be used to indicate system power and functionally. A flashing Indicator Light or other indicator (e.g. audible) may be used to indicate a low battery condition.

The Transmitter 16 will provide an authorization procedure to setup a communication link with a particular Receiver Module 42. During this procedure the Transmitter Module 16 will be programmed to process data only from the assigned Receiver 42.

Wireless System—Receiver Module

The alarm module 14 in the wireless configuration consists of a Microcontroller 46, Wireless Receiver 42, Power Supply 20, Power Switch, Indicator Lights, and an Audio alarm 22 or Transducer.

The Microcontroller 46 monitors the Wireless Receiver 42 for received data frames sent by the assigned Transmitter 36. The Microcontroller 46 will process received data frames and will activate the user interface Indicator Lights and Audio alarm 22 as necessary. When a data frame is received that indicates the remote Limit Point sensor 12 has been activated, the Microcontroller 46 will activate the Audio alarm 22 and a “Stop” Indicator Light, such as 50 in FIG. 2. When the received data frame indicates the remote Limit Point Sensor 12 has been deactivated, the Microcontroller 46 will deactivate the Audio alarm 22 and the “Stop” Indicator Light 50. The Microcontroller 46 will also provide a status indication of the wireless link. If the link with the Transmitter module 16 is lost or is unstable, the Microcontroller 46 will activate a defined Indicator Light and or activate an alarm tone. When the wireless link is reestablished, the Microcontroller 46 will deactivate the Indicator Light and alarm tone.

The Microcontroller 46 will only accept and process data frames sent by assigned Transmitter module 16.

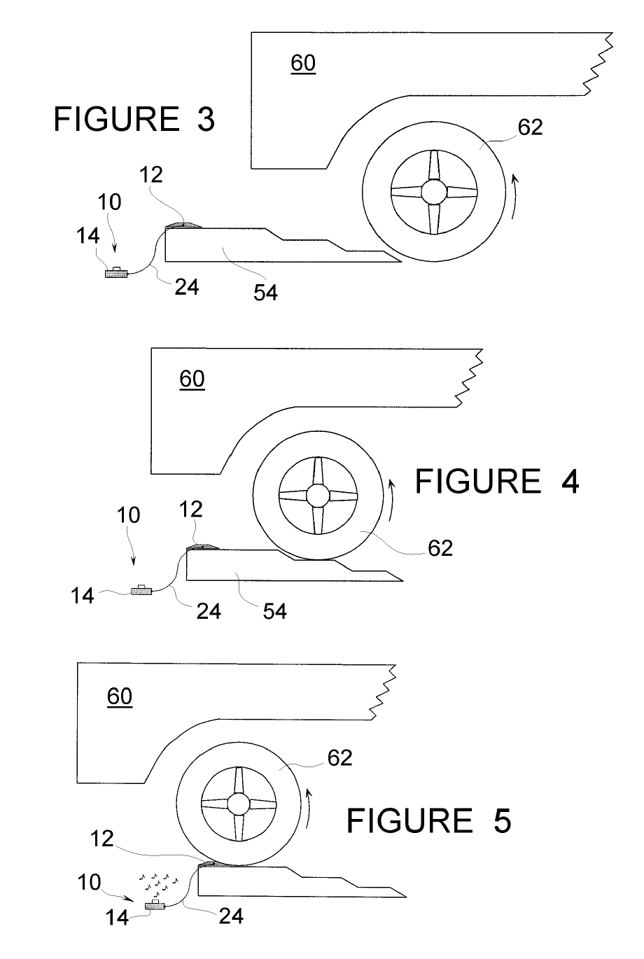

FIGS. 3-5 are schematic side elevation views of the steps of using the portable position sensor and alert system 10 for positioning a vehicle, namely a recreational vehicle 60, according to one aspect of the present invention. The device 10 can be utilized to aid in the positioning of RV's 60, and other vehicles, by providing an audible and or visual indication that the vehicle 60 has reached a predetermined limit point. This portable device 10 provides an accurate, easy-to-use, low cost limit point transition indication. By placing the limit sensor strip 12 at the desired limit point (i.e. end of leveling blocks 54 or maximum desired travel as shown in FIGS. 3-5), the operator is free to move the vehicle 60 (FIG. 4) until an audible or visual alarm is activated (FIG. 5). The device 10 provides a loud audible alarm that can be heard from within the cab of a tow vehicle, motor-home or other vehicle when the tire 62 of the RV reaches the sensor 12. Alerted that the predefined limit of travel has been reached, the operator can halt the movement of the vehicle 60.

The device 10′, that uses wireless technology, can be used in the substantially the same manner as device 10. However, with this configuration the limit point sensor 12 is to be linked to the remote receiver 42 of the alarm module 14 that can be located inside the vehicle driver's compartment via a wireless telemetry link. Activation of the limit point sensor 12 by the vehicle tire 62 will trigger audible and or visual alarms in the remote receiver unit 14 that can be easily detected by the operator.

Although the present invention has been described with particularity herein, the scope of the present invention is not limited to the specific embodiment disclosed. It will be apparent to those of ordinary skill in the art that various modifications may be made to the present invention without departing from the spirit and scope thereof. The scope of the present invention is defined in the appended claims and equivalents thereto.

What is claimed is:

1. A vehicle position sensor and alert system comprising:
A limit point sensor configured to be positioned by the user in a position to receive at least one tire of the vehicle to be positioned thereon when the vehicle is in a desired position, wherein the sensor is configured to generate a signal when the tire is positioned thereon; and
An alarm coupled to the sensor and actuated at least initially when the sensor generates the signal that the vehicle is in the desired position.

2. The vehicle position sensor and alert system of claim 1 wherein the limit point sensor is a portable water resistant flexible strip that provides an electrical signal.

3. The vehicle position sensor and alert system of claim 2 wherein the portable limit point sensor has a length of about 1-4 feet.

4. The vehicle position sensor and alert system of claim 1 wherein the alarm includes an audible component and further including tone generating circuitry that will drive the audible alarm.

5. The vehicle position sensor and alert system of claim 1 further including an alarm timeout feature that terminates alarm activation after a defined interval if continuous force is applied to the Limit Point Sensor.

6. The vehicle position sensor and alert system of claim 1 wherein the alarm includes an audible component and wherein audible alarm is configured to emit a sweeping tone that alternates between a low and a high audio frequency.

7. The vehicle position sensor and alert system of claim 1 further including a wireless transmitter module coupled to the limit point sensor and wherein the alarm is coupled to a wireless receiver, whereby the audible alarm may be remote from the limit point sensor.

8. The vehicle position sensor and alert system of claim 7 wherein the receiver will process received data transmissions only from the associated transmitter.

9. The vehicle position sensor and alert system of claim 7 further including a status indication of the wireless link.

10. The vehicle position sensor and alert system of claim 1 wherein the alarm further includes a visual indicator light that indicates that the Limit Point sensor has been activated.

11. The vehicle position sensor and alert system of claim 1 further including at least one leveling block for leveling the vehicle in the desired position.

12. A portable vehicle leveling and position sensor and alert system comprising:
A portable water resistant flexible strip including a limit point sensor configured to be positioned by the user in a position to receive at least one tire of the vehicle to be positioned thereon when the recreational vehicle is in a desired position, wherein the sensor is configured to generate a signal when the tire is positioned thereon; and
An alarm coupled to the sensor and actuated at least when the sensor generates the signal that the vehicle is in the desired position.

13. The portable vehicle position sensor and alert system of claim 12 further including a wireless transmitter module coupled to the limit point sensor and wherein the audible alarm is coupled to a wireless receiver, whereby the audible alarm may be remote from the limit point sensor.

14. The portable vehicle position sensor and alert system of claim 12 wherein the alarm includes a visual indicator light that indicate that the remote Limit Point sensor has been activated.

15. The portable vehicle position sensor and alert system of claim 12 further including at least one recreational vehicle leveling block for leveling the recreational vehicle in the desired position.

16. The portable vehicle position sensor and alert system of claim 12 further including an alarm timeout feature that terminates alarm activation after a defined interval if continuous force is applied to the Limit Point Sensor.

17. A method of positioning a recreational vehicle using a portable position sensor and alert system comprising the steps of:
Placing a limit sensor of the system at a desired limit point for a tire of the vehicle, whereby the limit sensor is placed at a position to receive at least one tire of the recreational vehicle to be positioned thereon when the recreational vehicle is in a desired position;
Supplying power to the system;
Moving the vehicle until at least one tire is positioned on the limit sensor;
Generating a signal from the limit sensor that the tire is positioned thereon; and
Driving at least one of an audible alarm or visible alarm of the system in response to the signal from the limit sensor; and
Stopping the vehicle when the alarm is heard by the operator.

18. The method of positioning a recreational vehicle using a portable position sensor and alert system of claim 17 further including the step of terminating the alarm activation after a defined interval if continuous force is applied to the Limit Point Sensor.

19. The method of positioning a recreational vehicle using a portable position sensor and alert system of claim 17 wherein the system further includes a wireless transmitter module coupled to the limit point sensor and wherein the audible alarm is coupled to a wireless receiver, further including the step of positioning the alarm within the vehicle cab during positioning of the vehicle.

20. The method of positioning a recreational vehicle using a portable position sensor and alert system of claim 17 further including the step of utilizing the limit sensor on at least one leveling block for leveling the vehicle in the desired position.
